(19) United States
(12) Patent Application Publication
(10) Pub. No.: US 2017/0151875 A1
(43) Pub. Date: Jun. 1, 2017

(54) DETECTING POSITION MEASUREMENT ERRORS IN AN ELECTRIC MOTOR SYSTEM

(71) Applicant: Faraday&Future Inc., Gardena, CA (US)

(72) Inventors: Mengwei Campbell, Torrance, CA (US); Jie Dang, Torrance, CA (US)

(73) Assignee: Faraday&Future Inc.

(21) Appl. No.: 14/954,963

(22) Filed: Nov. 30, 2015

(51) Int. Cl. B60L 3/12; G01D 5/20

(52) U.S. Cl. CPC B60L 3/12; G01D 5/2006

(57) ABSTRACT

Systems and methods are disclosed for detecting position measurement errors for an electric motor. An exemplary system may include a position sensor configured to measure a position of a rotor of the electric motor. The system may also include an error detector configured to detect an offset between the position measured by the position sensor and an actual position of the rotor. The error detector may include a signal injector configured to inject a probing signal to a stator of the electric motor. The error detector may also include a signal sampler configured to sample a response signal from the stator of the electric motor. The error detector may be configured to derive the offset based on the response signal.

### TECHNICAL FIELD

This disclosure relates generally to control of electric or electrical motors, and more particularly, to systems and methods for detecting position measurement errors of an electric motor system.

### BACKGROUND

Closed loop control is commonly used to regulate motor torques of high performance AC motors, such as interior permanent magnet (IPM) motors or other types of synchronous electric motors. In a typical closed loop control system, accurate information of the rotational position of a rotor of the motor is required to effectively drive the motor. The position of the rotor is typically measured using a position sensor. For example, a resolver may measure the position of the motor rotor by measuring a position of a resolver rotor that is co-axial and co-rotating with the motor rotor. However, due to factors such as manufacture variations and tolerances, the relative position between the resolver (e.g., the resolver rotor) and the motor rotor is subject to errors, resulting in position measurement errors. The position measurement errors may cause inefficiencies in control and energy consumption, instability in motor operation, or other adverse effects. For example, when an IPM motor supplies motive torque in a vehicle propulsion system, the position measurement errors may cause reduced driving range, reduced torque, and increased noise and vibration.

The present disclosure is directed to overcoming or mitigating the adverse effects caused by position measurement errors.

### SUMMARY

In one aspect, the present disclosure is directed to a system for controlling an electric motor. The system may include a position sensor configured to measure a position of a rotor of the electric motor. The system may also include an error detector configured to detect an offset between the position measured by the position sensor and an actual position of the rotor. The error detector may include a signal injector configured to inject a probing signal to a stator of the electric motor. The error detector may also include a signal sampler configured to sample a response signal from the stator of the electric motor. The error detector may be configured to derived the offset based on the response signal.

In another aspect, the present disclosure is directed to a method for detecting position measurement errors for an electric motor. The method may include measuring, by a position sensor, a position of a rotor of the electric motor. The method may also include injecting a probing signal to a stator of the electric motor. The method may further include sampling a response signal from the stator of the electric motor. In addition, the method may include deriving, based on the response signal, an offset between the position measured by the position sensor and an actual position of the rotor.

In a further aspect, the present disclosure is directed to a motor system. The motor system may include an electric motor including a rotor and a stator. The motor system may also include a motor control system configured to control the electric motor. The motor control system may include a position sensor configured to measure a position of the rotor. The motor control system may also include an error detector configured to detect an offset between the position measured by the position sensor and an actual position of the rotor. The error detector may include a signal injector configured to inject a probing signal to the stator. The error detector may also include a signal sampler configured to sample a response signal from the stator. In addition, the error detector may be configured to derived the offset based on the response signal.

In a further aspect, the present disclosure is directed to a chassis for a vehicle. The chassis may include a propulsion system for providing motive torques to at least one wheel of the vehicle. The propulsion system may include an energy storage device configured to store electric energy. The propulsion system may also include an electric motor including a rotor and a stator. The propulsion system may further include a motor control system configured to control energy transfer between the energy storage device and the electric motor. The motor control system may include a position sensor configured to measure a position of the rotor. The motor control system may also include an error detector configured to detect an offset between the position measured by the position sensor and an actual position of the rotor. The error detector may include a signal injector configured to inject a probing signal to the stator. The error detector may also include a signal sampler configured to sample a response signal from the stator. In addition, the error detector may be configured to derived the offset based on the response signal.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the claims.

### BRIEF DESCRIPTION OF THE DRAWINGS

FIG. 1 is a block diagram of an exemplary embodiment of a vehicle equipped with an electric motor propulsion system;

FIG. 2 is a graphical representation of an exemplary offset between an actual rotor position and a measured rotor position in a reference frame;

FIG. 3 is a block diagram of an exemplary embodiment of a motor control system;

FIG. 4 is a block diagram of an exemplary embodiment of a motor control system including an exemplary implementation of a rotor position measurement error detector; and

FIG. 5 is a flow chart illustrating an exemplary method of detecting rotor position measurement errors.

### DETAILED DESCRIPTION

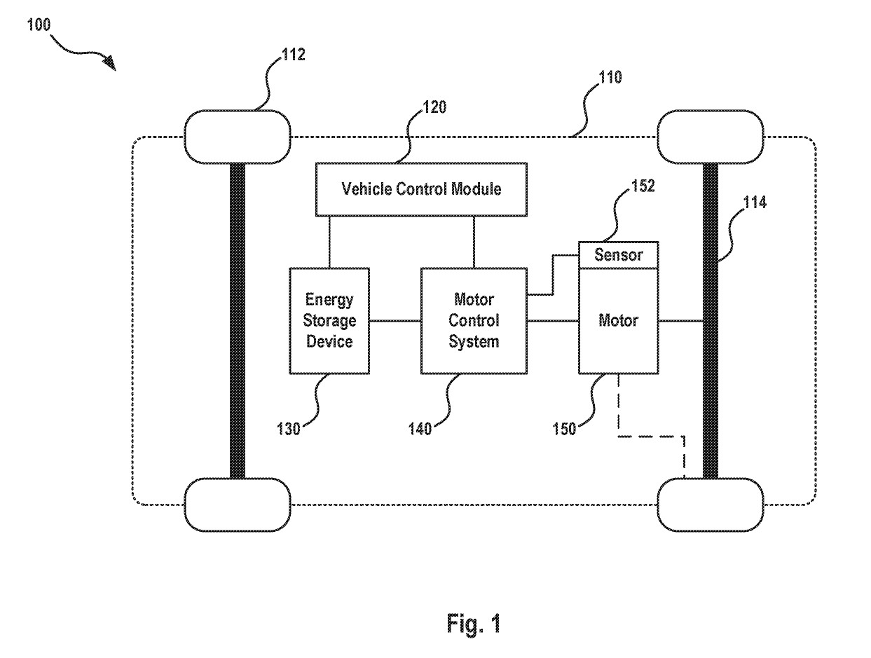

FIG. 1 is a block diagram of an exemplary embodiment of a vehicle 100, according to one aspect of the disclosure. As shown in FIG. 1, vehicle 100 may include a chassis 110 and a plurality of wheels 112. Chassis 110 may be mechanically coupled to wheels 112 by, for example, a suspension system. Vehicle 100 may also include an electric or electrical motor propulsion system. For example, vehicle 100 may include one or more electric motors, such as motor 150, to supply motive torque. Wheels 112 may be coupled to motor 150 in various ways. In one embodiment, as illustrated in FIG. 1, opposite wheels may be connected through a shaft 114, which may be mechanically coupled to motor 150 to transmit torque and rotation from motor 150 to the connecting wheels. In another embodiment, motor 150 may drive individual wheels directly, as illustrated, in a simplified manner, by a dashed line from motor 150 to the lower right wheel. For example, motor 150 may be located close to a wheel to provide driving power directly to the wheel. In this case, multiple motors may be used and each wheel may be driven by a separate motor or a group of motors. In another example, motor 150 may be built into a wheel such that the wheel may rotate co-axially with a rotor of the motor.

Motor 150 may be an AC synchronous electric motor including a rotor and a stator (not shown). The stator may include a plurality of poles, with each pole including windings connected to an AC power source, such as a three-phase AC power source. During operation, the AC powered stator may generate a rotating magnetic field to drive the rotor to rotate. The rotor may include windings and/or permanent magnet(s) to form a magnet such that the north/south pole of the magnet is continuously attracted by the south/north pole of the rotating magnetic field generated by the stator, thereby rotating synchronously with the rotating magnetic field. Exemplary AC synchronous electric motors include interior permanent magnet (IPM) motors, reluctance motors, and hysteresis motors. In some embodiments, the control system and method disclosed herein may also be used to control other types of motors.

Motor 150 may be controlled by a motor control system 140. Motor control system 140 may regulate energy transfer from an energy storage device 130 to motor 150 to drive motor 150. In some embodiments, motor 150 may operate in a generator mode, such as when vehicle 100 undergoes speed reduction or braking actions. In the generator mode, the excess motion energy may be used to drive motor 150 to generate electrical energy and feed the energy back to energy storage device 130 through motor control system 140. In some embodiments, energy storage device 130 may include one or more batteries to supply DC power. Motor control system 140 may include a DC-AC inverter to convert the DC power supplied by energy storage device 130 into AC driving power to drive motor 150. For example, the DC-AC invertor may include power electronic devices operating under a pulse-width modulation (PWM) scheme to convert the DC power into AC power.

Vehicle 100 may include a vehicle control module 120 to provide overall control of vehicle 100. For example, vehicle control module 120 may act as an interface between user operation and propulsion system reaction. For example, when a driver depresses an acceleration pedal of vehicle 100, vehicle control module 120 may translate the acceleration operation into a torque value to be output by motor 150, a target rotation speed of motor 150, or other similar parameters to be executed by the propulsion system. Vehicle control module 120 may be communicatively connected to motor control system 140 to supply commands and/or receive feedback. Vehicle control module 120 may also be communicatively connected to energy storage device to monitor operation status such as energy level, temperature, recharge count, etc.

A sensor 152 may detect the position of the rotor of motor 150. For example, sensor 152 may be a resolver assembly including a resolver stator and a resolver rotor. The resolver rotor may be affixed to the motor rotor concentrically or coaxially such that both the resolver rotor and the motor rotor rotate synchronously. The resolver rotor may include a plurality of lobes having eccentricities such that, when rotating, the position of the resolver rotor may be determined by detecting the proximity of the lobed resolver rotor to the resolver stator. The position of the motor rotor may then be determined based on the position of the resolver rotor. Motor control system 140 may receive the positional information as feedback data to determine the proper power application scheme (e.g., PWM switching timing).

For synchronous electric motors such as IPM motors, accurate motor rotor position information may be important to regulate power application. However, due to factors such as manufacture variations and tolerance, the relative position between resolver rotor and motor rotor is subject to error. For example, the error may be due to misalignment between the resolver rotor and the motor rotor. The actual position of the motor rotor may be represented by a direct-quadrature (d-q) coordinate in a reference frame. Similarly, the position of the resolver rotor, which is also the measured position of the motor rotor, can be represented by another d-q coordinate in the reference frame. In the reference frame (e.g., the d-q reference frame), the field flux linkage component (along the d axis) and the torque component (along the q axis) of a three-phase AC signal are decoupled to orthogonal directions d and q. Therefore, the misalignment may be quantified by an angular offset Δθ between the d axis of the motor rotor and the d axis of the resolver rotor.

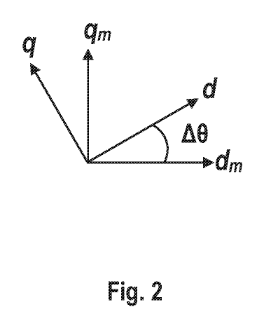

FIG. 2 is a graphical representation of an exemplary offset Δθ between an actual motor rotor position (indicated by the d axis) and a measured motor rotor position (indicated by the dₘ axis) in a d-q reference frame. In some cases, the value of Δθ may change over time. Therefore, repeated calibrations may be needed to determine the accurate value of Δθ. Embodiments disclosed in this application provide a convenient solution to detect Δθ. For example, Δθ may be detected every time before the motor is started or within a relatively short time after starting. In another example, detection of Δθ may be performed periodically according to a maintenance schedule. In another example, detection of Δθ may be performed on demand In another example, detection of Δθ may be performed when a key to vehicle 100 disengages vehicle 100.

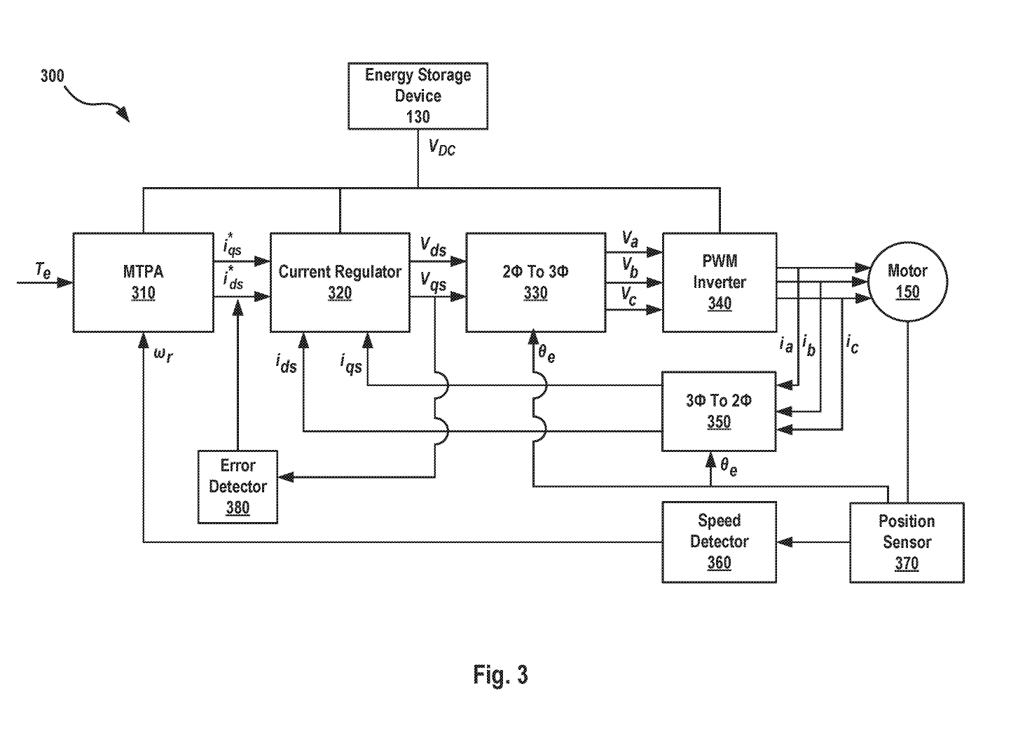

FIG. 3 is a block diagram of an exemplary embodiment of a motor control system 300 including an error detector 380 for detecting position measurement errors. Motor control system 300 may include a Maximum Torque Per Ampere (MTPA) module 310. MTPA module 310 may receive a torque command Tₑ from, for example, vehicle control module 120, and generate corresponding d axis and q axis components of a current command (i_{ds}*, and i_{qs}*). For example, MTPA module 310 may include a look-up table storing mapping relations between values of Tₑ and values of i_{ds}*, and i_{q}*, for a given rotational speed ωᵣ and a given DC voltage V_{Dc}. The current command may be input to a current regulator 320. Current regulator may determine the difference between i_{ds}*, and feedback current i_{ds} and the difference between i_{qs}*, and feedback current i _{qs} to control a voltage command (V_{ds} and V_{qs}). The voltage command in the d-q reference frame may be converted into actual phase voltages (Vₐ, V_{b}, and V_{c}) by a two-phase to three-phase transformer 330. The actual phase voltages may be input to a PWM invertor 340 to drive motor 150. Phase currents (iₐ, i_{b}, and i_{c}) may be measured and processed by a three-phase to two-phase transformer 350 to provide feedback currents (i_{ds}, and i_{qs}) in d-q reference frame to current regulator 320. A position sensor 370 may be used to measure the rotor position and provide the measured position information θₑ to transformers 330 and 350. The position information may also be used by a speed detector 360 to determine the rotational speed ωᵣ. As discussed above, the measured position information may contain errors. For example, the actual rotor position may have an offset Δθ compared to the measured position θₑ.

As shown in FIG. 3, motor control system 300 may include a position measurement error detector 380 configured to detect one or more position measurement errors. For example, error detector 380 may detect the offset Δθ by applying a probing signal to motor 150 and measuring a response signal. The probing signal may be applied as a current command (e.g., i_{ds}) input to current regulator 320 during a predetermined time period or when motor 150 is operating under a predetermined condition. For example, the probing signal may be in the form of a high frequency current signal injected into the stator of motor 150. The high frequency current signal may be injected when the rotor of motor 150 is in a stall position, during a startup process, or within a relative short period after the rotor of motor 150 starts to rotate (e.g., within 0.5 second, 1 second, 2 second, 5 second, etc.). In another example, the high frequency current signal may be injected when the rotational speed of the rotor is below a predetermined threshold (e.g., below 1%, 2%, 5%, or 10% of the normal operating speed). The response signal may be obtained by measuring the stator voltage of motor 150. For example, the response signal may be obtained from the voltage command (e.g., V_{qs}) at the output of current regulator 320. Error detector 380 may determine the position measurement error (e.g., Δθ) based on the response signal. In some embodiments, error detector 380 may be implemented by one or more processor devices executing an algorithm and/or instructions stored in a memory device. In some embodiments, error detector 380 may be implemented by one or more circuits configured to perform functions such as signal application or injection, signal sampling, signal filtering, signal amplification or attenuation, logical operation, etc. In some embodiments, error detector 380 may be implemented by a combination of processor device(s) and circuit(s).

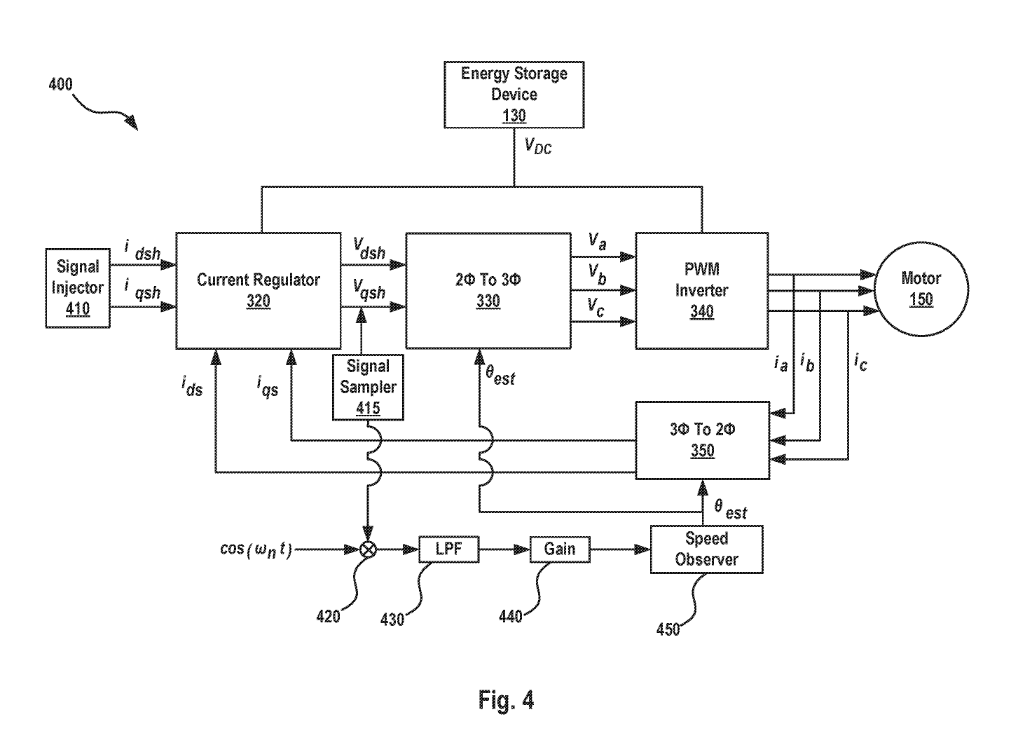

FIG. 4 is a block diagram of an exemplary embodiment of a motor control system 400 including an exemplary implementation of the rotor position measurement error detector 380. In the embodiment shown in FIG. 4, motor 150 may be a synchronous motor such as an IPM motor. In this case, the d-q reference frame is a synchronous frame. The voltages in the synchronous frame can be represented as follows:

$$\begin{matrix}{V}_{ds} = {R}_{s} {i}_{ds} + {L}_{ds} \frac{d {i}_{ds}}{d t} - {ω}_{e} {L}_{qs} {i}_{qs} & ( 1 ) \\ {V}_{qs} = {R}_{s} {i}_{qs} + {L}_{qs} \frac{d {i}_{qs}}{d t} + {ω}_{e} {L}_{ds} {i}_{ds} + {ω}_{e} {λ}_{f} & ( 2 )\end{matrix}$$

where Rₛ is stator resistance, ωₑ is electrical speed, V_{ds}, V_{qs} are voltages, i_{ds}, i_{qs} are currents, and L_{ds}, L_{qs} are the inductances in the synchronous frame. λ_{f} is permanent magnet flux linkage.

As shown in FIG. 4, a signal injector 410 may inject a probing signal into the stator of motor 150. If the probing signal is injected when the motor speed is almost zero or below a predetermined threshold, the voltage drop across the stator resistance and the back electromotive force (EMF) voltage drop can be ignored. Therefore, the voltage equations (1) and (2) can be simplified to equations (3) and (4), respectively.

$$\begin{matrix}{V}_{dsh} = {L}_{ds} \frac{d {i}_{dsh}}{d t} & ( 3 ) \\ {V}_{qsh} = {L}_{qs} \frac{d {i}_{qsh}}{d t} & ( 4 )\end{matrix}$$

where i_{dsh}, i _{qsh} are the current components of the injected probing signal in the rotor reference frame, and V_{dsh}, V_{qsh} are the voltage components in the rotor reference frame.

If there is an error (e.g., an offset Δθ) between the actual rotor position and the measured rotor position θₑ that is used in motor control, then the voltage equation can be represented as equation (5):

$$[ \begin{matrix}{\hat{V}}_{dsh} \\ {\hat{V}}_{qsh}\end{matrix} ] = [ \begin{matrix}\frac{{L}_{d} + {L}_{q}}{2} - \frac{{L}_{q} - {L}_{d}}{2} cos ( 2 Δθ ) & \frac{{L}_{q} - {L}_{d}}{2} sin ( 2 Δθ ) \\ \frac{{L}_{q} - {L}_{d}}{2} sin ( 2 Δθ ) & \frac{{L}_{d} + {L}_{q}}{2} + \frac{{L}_{q} - {L}_{d}}{2} cos ( 2 Δθ )\end{matrix} ] \frac{d}{d t} [ \begin{matrix}{\hat{l}}_{dsh} \\ {\hat{l}}_{qsh}\end{matrix} ] \qquad ( 5 )$$

where \hat{V}_{dsh}, \hat{V}_{qsh} are voltage components of the response signal considering the effect of the error Δθ.

The probing signal supplied by signal injector 410 may be in the form of a high-frequency current signal injected into the stator of motor 150, the high-frequency current signal can be represented in equation (6):

$$[ \begin{matrix}{\hat{l}}_{dsh} \\ {\hat{l}}_{qsh}\end{matrix} ] = {I}_{s} [ \begin{matrix}sin ( {ω}_{n} t ) \\ 0\end{matrix} ] \qquad ( 6 )$$

where ωₙ is the high frequency, which may be in a range from 300 Hz to 800 Hz. The amplitude of the current signal Iₛ may be in a range from 100 A to 400 A.

The corresponding voltage response can be represented in equation (7):

$$[ \begin{matrix}{\hat{V}}_{dsh} \\ {\hat{V}}_{qsh}\end{matrix} ] = {I}_{s} {ω}_{n} [ \begin{matrix}( \frac{{L}_{d} + {L}_{q}}{2} - \frac{{L}_{q} - {L}_{d}}{2} cos ( 2 Δθ ) ) cos ( {ω}_{n} t ) \\ \frac{{L}_{q} - {L}_{d}}{2} sin ( 2 Δθ ) cos ( {ω}_{n} t )\end{matrix} ] \qquad ( 7 )$$

Equations (7) shows that the position error Δθ is contained in the voltage response. For example, the q-axis voltage response \hat{V}_{qsh} is represented in equation (8):

$${\hat{V}}_{qsh} = {I}_{s} {ω}_{n} \frac{{L}_{q} - {L}_{d}}{2} sin ( 2 Δθ ) cos ( {ω}_{n} t ) \qquad ( 8 )$$

The q-axis voltage response may be sampled by a signal sampler 415. The position error Δθ can be extracted or derived from the sampled q-axis voltage response in a signal demodulation process. For example, the q-axis voltage response \hat{V}_{qsh} can be demodulated by multiplying a signal cos(ωₙt) at junction 420, as follows:

$$\begin{matrix}{\hat{V}}_{qsh} cos ( {ω}_{n} t ) = {I}_{s} {ω}_{n} \frac{{L}_{q} - {L}_{d}}{2} sin ( 2 Δθ ) {cos}^{2} ( {ω}_{n} t ) \\ = {I}_{s} {ω}_{n} \frac{{L}_{q} - {L}_{d}}{2} sin ( 2 Δθ ) \frac{1 + cos ( 2 {ω}_{n} t )}{2}\end{matrix}$$

The demodulated q-axis voltage response may be low-pass filtered (LPF) by a filter 430 to remove the high frequency component, as follows:

$$LPF [ {\hat{V}}_{qsh} cos ( {ω}_{n} t ) ] = {I}_{s} {ω}_{n} \frac{{L}_{q} - {L}_{d}}{2} \frac{sin ( 2 Δθ )}{2} \approx {I}_{s} {ω}_{n} \frac{{L}_{q} - {L}_{d}}{2} Δθ$$

because when Δθ is small, sin(2Δθ)≈2Δθ.

Then the position measurement error Δθ can be represented as follows:

$$Δθ \approx \frac{2 \times LPF [ {\hat{V}}_{qsh} cos ( {ω}_{n} t ) ]}{{I}_{s} {ω}_{n} ( {L}_{q} - {L}_{d} )} = G \times LPF [ {\hat{V}}_{qsh} cos ( {ω}_{n} t ) ]$$

where

$$G = \frac{2}{{I}_{s} {ω}_{n} ( {L}_{q} - {L}_{d} )}$$

is a gain factor that can be applied to the output of filter 430 by an amplifier 440. The gain factor may depend on the inductance (e.g., L_{q}, L_{d}) of motor 150. In some embodiments, the rotor position may be estimated using a speed observer 350 or a speed PID controller without considering the specific motor parameters. For example, the output of amplifier 440, which is a signal indicating position measurement error Δθ, can be input to speed observer 450 or a speed PID controller. Speed observer 450 may generate an estimated position θₑₛₜ. When the rotational speed of the rotor is zero or relatively low, the actual speed and position are zero or close to zero. Therefore, the estimated position θₑₛₜ may be equal to or close to the offset angle Δθ. The measurement position information may then be corrected or compensated by a controller (not shown) by adding or subtracting the offset angle Δθ (e.g., the estimated offset angle θₑₛₜ) to generate an accurate position information as feedback signal to transformers 330 and 350. The detected error information may be stored in a memory device for later uses. In some embodiments, after the error information is determined and stored, error detector 380 may enter into an idle state and motor control may be performed using control system 300 shown in FIG. 3.

In some embodiments, the error detection process may be performed as part of a startup procedure for motor 150. In some embodiments, the error detection process may be performed according to a maintenance or calibration schedule. In this case, the detected error information may be stored in a non-volatile memory device such that the error information can be used in subsequent motor operations until the error information is updated.

The embodiment shown in FIG. 4 injects a high frequency current probing signal having only a d-axis component and samples the q-axis response voltage signal. In some embodiments, other types of probing and/or response signals may also be used. For example, as shown in equation (7), the d-axis response voltage signal can be similarly demodulated to extract the error signal Δθ. In another example, a probing signal having only a q-axis component or having both d-axis and q-axis components may be used.

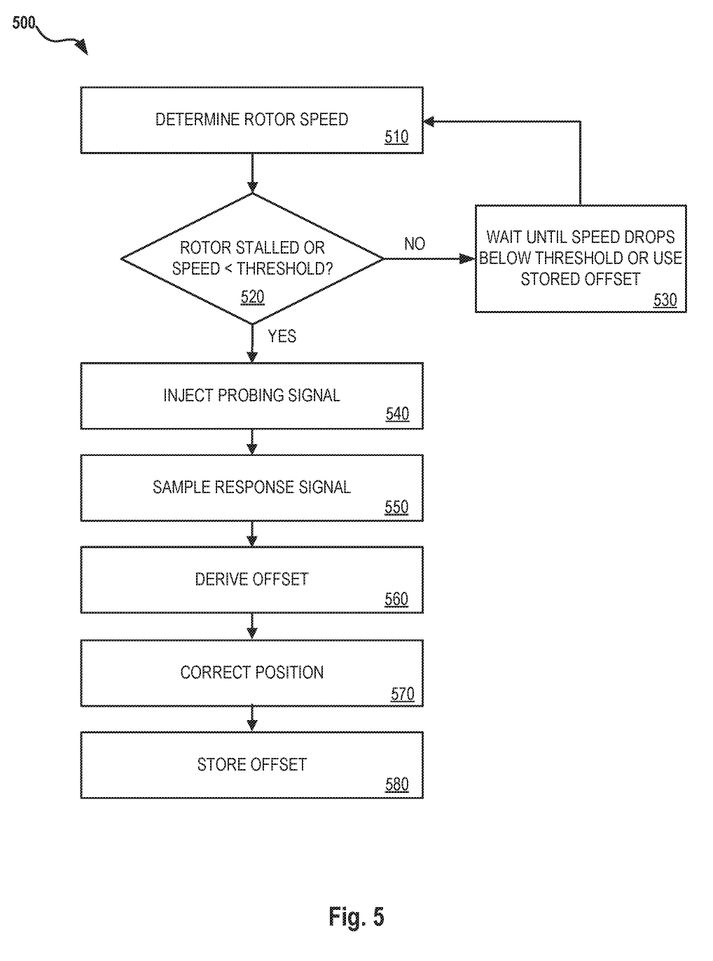

FIG. 5 is a flowchart depicting a method 500 for detecting rotor position measurement errors, according to an embodiment of this disclosure. Method 500 includes a plurality of steps, some of which may be optional. Method 500 may be carried out by a processor device executing an algorithm and/or instructions, by dedicated circuitries configured to perform one or more specific functions, or by a combination thereof.

In step 510, motor control system 140 may determine the speed of the rotor. For example, the speed may be determined using a position sensor or a speed sensor. When the motor is stalled, the speed of the rotor is zero.

In step 520, motor control system 140 may determine whether the speed of the rotor is zero (stalled) or is not zero but below a predetermined threshold (e.g., below 1%, 2%, 5%, or 10% of the normal operating speed). If the speed is not below the threshold, then motor control system 140 may wait until the speed is below the threshold or use a stored offset to control the motor (step 530).

In step 540, after motor control system 140 determines that the rotor is either stalled or has a relatively low speed in relation to the predetermined threshold, motor control system 140 may start the position measurement error detection process to detect an offset between a measured position and an actual position of the rotor. In step 540, signal injector 410 may inject a probing signal, such as a high frequency current signal, to the stator of the motor.

In step 550, signal sampler 415 may sample a response signal in response to the injection of the probing signal. For example, signal sampler 415 may sample the response signal as a voltage signal in the d-q reference frame.

In step 560, error detector 380 may derive the offset based on the sampled response signal. For example, error detector 380 may demodulate, filter, and/or amplify the response signal and/or use speed observer 450 or a speed PID controller to generate the offset signal.

In step 570, error detector 380 may supply the offset to a controller to correct the measured position. The controller may correct the rotor position measured by position sensor 370 by adding or subtracting the offset and provide the corrected rotor position to transformers 330 and 350.

In step 580, the offset may be saved in a memory device for later use. For example, the stored offset may be used to correct position measurement errors when the rotor speed is higher than the threshold speed (e.g., in step 530). In another example, when the position measurement error detection process is not performed in a particular motor operation session, the stored offset may be used to correct the measured rotor position.

The embodiments disclosed above include systems and methods for detecting position measurement errors in electric motors. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed embodiments are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be used in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples of computer-readable media include RAM, ROM, volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

1. A system for controlling an electric motor, the system comprising:
a position sensor configured to measure a position of a rotor of the electric motor;
an error detector configured to detect an offset between the position measured by the position sensor and an actual position of the rotor, the error detector including:
a signal injector configured to inject a probing signal to a stator of the electric motor, wherein the probing signal includes a high frequency current signal; and
a signal sampler configured to sample a response signal from the stator of the electric motor;
wherein the error detector is configured to derive the offset based on the response signal; and
a current regulator, wherein:
the signal injector is configured to inject the probing signal by inputting a current command in a reference frame to the current regulator; and
the signal sampler is configured to sample the response signal by receiving a voltage command in the reference frame from the current regulator.

2. The system of claim 1, wherein the error detector is configured to:
demodulate the response signal;
filter the demodulated response signal; and
apply a gain factor to the filtered and demodulated response signal to derive the offset.

3. (canceled)

4. The system of claim 1, wherein the high frequency current signal has a frequency in a range between 300 Hz and 800 Hz.

5. (canceled)

6. The system of claim 1, wherein the error detector is configured to detect the offset when the rotor of the electric motor is in a stall position.

7. The system of claim 1, wherein the error detector is configured to detect the offset when a speed of the rotor of the electric motor is below a predetermined threshold.

8. The system of claim 1, wherein the error detector is configured to supply the detected offset to the position sensor to correct the position measured by the position sensor.

9. A method for detecting position measurement errors for an electric motor, the method comprising:
measuring, by a position sensor, a position of a rotor of the electric motor;
injecting a probing signal to a stator of the electric motor by inputting a current command in a reference frame to a current regulator, wherein the probing signal includes a high frequency current signal;
sampling a response signal from the stator of the electric motor by receiving a voltage command in the reference frame from the current regulator; and
deriving, based on the response signal, an offset between the position measured by the position sensor and an actual position of the rotor.

10. The method of claim 9, further comprising:
demodulating the response signal;
filtering the demodulated response signal; and
applying a gain factor to the filtered and demodulated response signal to derive the offset.

11. (canceled)

12. The method of claim 9, wherein the high frequency current signal has a frequency in a range between 300 Hz and 800 Hz.

13. (canceled)

14. The method of claim 9, wherein injecting the probing signal includes:
injecting the probing signal when the rotor of the electric motor is in a stall position.

15. The method of claim 9, wherein injecting the probing signal includes:
injecting the probing signal when a speed of the rotor of the electric motor is below a predetermined threshold.

16. The method of claim 9, further comprising:
supplying the offset to the position sensor to correct the position measured by the position sensor.

17. A motor system, comprising:
an electric motor including a rotor and a stator; and
a motor control system configured to control the electric motor, the motor control system including:
a position sensor configured to measure a position of the rotor;
an error detector configured to detect an offset between the position measured by the position sensor and an actual position of the rotor, the error detector including:
a signal injector configured to inject a probing signal to the stator, wherein the probing signal includes a high frequency current signal; and
a signal sampler configured to sample a response signal from the stator;
wherein the error detector is configured to derive the offset based on the response signal; and
a current regulator, wherein:
the signal injector is configured to inject the probing signal by inputting a current command in a reference frame to the current regulator; and
the signal sampler is configured to sample the response signal by receiving a voltage command in the reference frame from the current regulator.

18. The motor system of claim 17, wherein the electric motor includes a synchronous electric motor.

19. The motor system of claim 18, wherein the electric motor includes an interior permanent magnet (IPM) motor.

20. A chassis for a vehicle, the chassis comprising:
a propulsion system for providing motive torques to at least one wheel of the vehicle, the propulsion system comprising:
an energy storage device configured to store electric energy;
an electric motor including a rotor and a stator; and
a motor control system configured to control energy transfer between the energy storage device and the electric motor, the motor control system including:
a position sensor configured to measure a position of the rotor;
an error detector configured to detect an offset between the position measured by the position sensor and an actual position of the rotor, the error detector including:
a signal injector configured to inject a probing signal to the stator, wherein the probing signal includes a high frequency current signal; and
a signal sampler configured to sample a response signal from the stator;
wherein the error detector is configured to derive the offset based on the response signal; and
a current regulator, wherein:
the signal injector is configured to inject the probing signal by inputting a current command in a reference frame to the current regulator; and
the signal sampler is configured to sample the response signal by receiving a voltage command in the reference frame from the current regulator.
